(19) United States
(12) Patent Application Publication
(10) Pub. No.: US 2019/0284849 A1
(43) Pub. Date: Sep. 19, 2019

(54) SLIDING DOOR CLOSURE SYSTEM FOR MOTOR VEHICLES WITH E-LATCH

(71) Applicant: MAGNA CLOSURES INC., Newmarket (CA)

(72) Inventors: Ioan Dorin ILEA, Vaughan (CA); Csaba SZENTE, Newmarket (CA); John DISTEFANO, Richmond Hill (CA)

(21) Appl. No.: 16/351,984

(22) Filed: Mar. 13, 2019

Related U.S. Application Data
(60) Provisional application No. 62/643,283, filed on Mar. 15, 2018.

(51) Int. Cl. E05B 83/40; E05B 81/54; E05B 63/18; B60J 5/06

(52) U.S. Cl. CPC E05B 83/40; E05B 81/54; E05Y 2900/531; B60J 5/06; E05B 63/18

(57) ABSTRACT

A vehicle sliding door and sliding door closure system therefor equipped with electrically actuatable component(s) that eliminate one or more of the mechanically actuatable component(s) of currently known vehicle sliding doors and sliding door closure systems.

### CROSS-REFERENCE TO RELATED APPLICATION

This application claims the benefit of U.S. Provisional Application Ser. No. 62/643,283, filed Mar. 15, 2018, which is incorporated herein by reference in its entirety.

### FIELD

The present disclosure relates generally to vehicle doors with electronic latch systems, and more particularly, to sliding vehicle doors with electronic latch systems.

### BACKGROUND

This section provides background information related to the present disclosure which is not necessarily prior art.

A motor vehicle sliding door typically includes a structural door body having an outer sheet metal door panel and an inner sheet metal door panel, a plurality of mechanically actuatable hardware components mounted within an internal cavity formed in the structural door body between the inner and outer door panels, and an interior trim panel, and mechanically actuatable cables/rods interconnecting the hardware components with one another. The assembly process for the door involves multiple manufacturing steps and numerous parts. Conventionally, each hardware component is assembled individually to the structural door body as it travels along an assembly line, while the mechanically actuatable cables/rods are routed in particular fashion to ensure they retain their ability to be mechanically actuated. This conventional assembly process has high assembly cycle times, which is ultimately costly. Further, the operability of the individual hardware components typically cannot be tested until the installation and assembly process is completed, and thus, if problems are detected after assembly, the entire time spent on assembly may be wasted. Further, each hardware component, including the cables/rods for operably connecting the hardware components to one another, must be inventoried and managed at the assembly facility.

In addition to the drawbacks discussed above with regard to the assembly processes for motor vehicle sliding doors, further aspects exists that could benefit from advancements. For example, as shown in FIG. 8, motor vehicle sliding doors 1 are known to include a mechanical front catch 2 and a mechanical rear latch 3 operably coupled to one another via mechanically actuatable inside and outside door handles 4, 5 via mechanical cables/rods, including an inside handle cable/rod 6, an outside handle cable/rod 6′ and front catch cable/rod 6″. Motor vehicle sliding doors 1 are further known to include a mechanical hold latch 7 mechanically coupled to inside/outside door handles 4, 5 via a hold latch cable/rod 6′″ for mechanical actuation to releasably maintain the motor vehicle sliding door 1 in a fully open position. Actuation of the front catch 2 and rear latch 3 is performed via selective mechanical actuation of the inside and outside door handles 4, 5, whereupon the actuation of the front catch 2 and rear latch 3 is generally intended to be simultaneous for smooth, synchronized release. As such, the mechanically actuatable cables/rods 6, 6′, 6″ extending therebetween must be assembled with care to ensure synchronized actuation of the front catch 2 and rear latch 3 occurs as desired. Unfortunately, as with all mechanical apparatus, play (also known as slack or slop) eventually results over time due to inherent creep/relaxation and wear of the physical apparatus. Thus, over time, servicing of the motor vehicle sliding door 1 may be needed to replace worn cables/rods/connectors within the expected useful life of the motor vehicle. In addition to the above drawbacks, the effort needed to release the motor vehicle sliding door 1 from a closed and/or locked state can be greater than desired as a result of inherent friction and tolerance stack-ups within the multiple mechanical components of the mechanical system, and particularly within the mechanically actuatable cables/rods 6, 6′ interconnecting the inside/outside door handles 4, 5 to the front catch 2 and rear latch 3. Further, the mechanically actuatable cables/rods 6, 6′, 6″ can be inadvertently actuated in a vehicle crash condition due to inertial effects thereon, which can result in an unintended unlatching and release of the motor vehicle sliding door 1. Additionally, if the motor vehicle sliding door 1 is impacted in a crash condition, the mechanically actuatable cables/rods 6, 6′, 6″ can be inadvertently damaged, tugged and actuated, which can result in an unintended unlatching and release of the motor vehicle sliding door 1. Further yet, mechanically actuatable rods and cables, such as Bowden cables, are typically stiff, and thus, can be challenging to route over meandering paths as needed to connect one mechanically actuatable component to another, and are typically bulky, and thus, add mass to the motor vehicle, which ultimately reduces fuel efficiency, and further yet, can complicate the ability to effectively seal the panels of the door against water intrusion. In addition to the above drawbacks, further issues can result, such as those related to noise generated within the moving mechanical components, styling and lack of ability to impart styling variations due to the need to make mechanical connections between the operable components of the mechanical latch, catch and hold devices.

Thus, a need exists to develop improved vehicle sliding doors to address at least those drawbacks discussed above.

### SUMMARY

This section provides a general summary of some of the objects, advantages, aspects and features provided by the inventive concepts associated with the present disclosure. However, this section is not intended to be considered an exhaustive and comprehensive listing of all such objects, advantages, aspects and features of the present disclosure.

In accordance with one aspect, the present disclosure is directed to a vehicle door closure system that advances the art and improves upon currently known vehicle door systems having primarily mechanically actuated door handles, latches, catches, locks and the like.

In accordance with one aspect, the present disclosure is directed to a vehicle sliding door that advances the art and improves upon currently known vehicle sliding doors having primarily mechanically actuated door handles, latches, catches, locks and the like.

It is a related aspect to provide a vehicle sliding door equipped with electrically actuatable component(s) that eliminate one or more of the mechanically actuatable component(s) of currently known vehicle sliding doors.

It is a related aspect to provide a vehicle sliding door equipped with an electrically actuatable sliding door closure system that eliminates one or more of the mechanical connections between one or more of the inside door handle release mechanism and the outside door handle release mechanism.

It is a related aspect to provide a vehicle sliding door having an electrically actuatable rear latch configured in electrical communication with an electrically actuatable front catch, wherein the electrically actuatable rear latch is free of any mechanically actuated connections thereto.

It is a related aspect to provide a vehicle sliding door that improves door handle releasing efforts.

It is a related aspect to provide a vehicle sliding door that improves and maintains synchronization between latch release mechanisms over the useful life of the vehicle.

It is a related aspect to provide a vehicle sliding door that improves the timing of release between latch release mechanisms relative to one another and maintains the timing of release over the useful life of the vehicle.

It is a related aspect to provide a vehicle sliding door that inhibits inadvertent release of latch release mechanisms due to impact during a crash condition.

It is a related aspect to provide a vehicle sliding door that provides enhanced resistance to inadvertent release of a latch mechanism due to inertial effects during a crash condition.

It is a related aspect to increase the options available for door handle interface options of a vehicle sliding door.

It is a related aspect to enhance the design and packaging flexibility of a vehicle sliding door.

It is a related aspect to reduce the mass, reduce the noise generation, reduce the complexity of operation and reduce the number and complexity of assembly operations of a vehicle sliding door.

In accordance with an aspect of the disclosure, a door closure system for a motor vehicle door that is moveable between an open position and a closed position is provided. The door closure system includes an electrical first latch and an electrical second latch configured in electrical communication with a controller configured for controlling activation of the electrical first latch and the electrical second latch. The electrical first latch and the electrical second latch are electrically actuatable in direct response to selective electrical actuation of by the controller.

In accordance with another aspect of the disclosure, a sliding door closure system for a motor vehicle sliding door that is slidable between an open position and a closed position is provided. The sliding door closure system includes an electrical rear latch and an electrical front catch configured in electrical communication with one another. The electrical front catch is electrically actuatable in response to selective electrical actuation of the electrical rear latch.

In accordance with another aspect of the disclosure, a sliding door for a motor vehicle is provided. In a non-limiting embodiment, the sliding door includes a structural door body defining an internal cavity and sliding door closure system installed within the internal cavity. The sliding door closure system includes an electrical rear latch and an electrical front catch configured in electrical communication with one another, wherein selective electrical actuation of the electrical rear latch causes selectively timed electrical actuation of the electrical front catch.

In accordance with a further aspect, the selectively timed electrical actuation of the electrical front catch can be configured to be simultaneous with the electrical actuation of the electrical rear latch.

In accordance with a further aspect, the selectively timed electrical actuation of the electrical front catch can be configured to be delayed a predetermined amount of time relative to the electrical actuation of the electrical rear latch to minimize the severity of “popping” of a seal formed between the sliding door and a body of the motor vehicle.

In accordance with a further aspect, the sliding door can be provided with a holding latch configured to releasably maintain the sliding door in a fully open position, wherein the holding latch is configured in operable communication with the front catch.

In accordance with a further aspect, the front catch can be coupled to an actuator, with the actuator being configured to move the holding latch between the locked position and the released position.

In accordance with a further aspect, the actuator can configured to move the holding latch between the locked position and the released position in response to a signal from at least one of the electrical rear latch and at least one selectively actuatable electrical switch.

In accordance with a further aspect, the actuator can be configured in direct electrical communication with the electrical rear latch.

In accordance with a further aspect, the sliding door closure system can include an inside micro-switch mounted to an inner portion of the sliding door body so as to be located within a passenger compartment of the motor vehicle with an inner electrical connector electrically connecting the inside micro-switch to the electrical rear latch.

In accordance with a further aspect, the sliding door closure system can include an outside micro-switch that can be mounted to an outer portion of the sliding door body so as to be located outside of the passenger compartment, with an outer electrical connector electrically connecting the outside micro-switch to the electrical rear latch.

In accordance with another aspect of the disclosure, the inside micro-switch of the sliding door can be positioned on an interior trim panel and/or inside door handle of the sliding door.

In accordance with another aspect of the disclosure, the outside micro-switch of the sliding door can be located on an outside door handle.

In accordance with another aspect of the disclosure, the outside door handle of the sliding door can be free of any mechanical connections to the fully electrically actuatable electrical rear latch.

In accordance with another aspect of the disclosure, the inner and outer electrical connectors can be provided as electrical wires, thereby being able to be freely routed over meandering or straight paths, as desired, thus, providing great freedom for the design configuration of the sliding door while adding minimal mass.

In accordance with another aspect of the disclosure, the electrical rear latch can be free of any mechanical connections thereto, thereby being fully electrically actuatable.

In accordance with another aspect of the disclosure the sliding door can be free of mechanically actuatable inside and outside door handles, thereby greatly simplifying assembly, reducing the number of components needed for assembly, reducing costs associated with inventory and assembly, reducing weight, and freeing up space for desired design modifications.

In accordance with another aspect of the disclosure, a method of allowing sliding movement of a vehicle sliding door between a closed position and an open position is provided. The method includes installing a sliding door closure system within an internal cavity of the vehicle sliding door and providing the sliding door closure system including an electrically actuatable rear latch and an electrically actuatable front catch. Further, configuring the electrically actuatable rear latch and the electrically actuatable front catch in electrical communication with one another, and configuring the electrically actuatable front catch to be electrically actuated in response to selective electrical actuation of the electrically actuatable rear latch.

In accordance with another aspect, the method can further include configuring the electrically actuatable front catch to be electrically actuated in simultaneous response to electrical actuation of the electrically actuatable rear latch.

In accordance with another aspect, the method can further include configuring the electrically actuatable front catch to be electrically actuated in delayed response to electrical actuation of the electrically actuatable rear latch.

These and further areas of applicability will become apparent to those possessing ordinary skill in the art from the description provided herein. As noted, the description and any specific examples in this summary are intended for purposes of illustration only and are not intended to limit the scope of the present disclosure.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1A is a side view of a motor vehicle having a sliding door with a sliding door closure system in accordance with one aspect of the disclosure, with the sliding door shown in a fully open position;

FIG. 1B is a perspective view illustrating a portion of the motor vehicle of FIG. 1A with the sliding door shown in a fully closed position;

FIG. 2 is an interior side view of the sliding door of the motor vehicle of FIGS. 1 and 1A illustrating the sliding door closure system thereof;

FIG. 3 is a schematic actuation scheme associated with a sliding door in accordance with the present disclosure, illustrating the components and/or sub-assemblies eliminated in comparison to a conventional sliding door illustrated in the prior art of FIG. 8;

FIG. 4 illustrates the incorporation of an optional cinch actuator into a sliding door closure system in accordance with the present disclosure;

FIG. 5 illustrates the incorporation of an optional mechanical front catch into a sliding door closure system in accordance with the present disclosure;

FIG. 6A is a flow chart illustrating a sliding door opening sequence in accordance with one aspect of the present disclosure;

FIG. 6B is a flow chart illustrating a sliding door opening sequence in accordance with another aspect of the present disclosure;

FIG. 7 is a flow chart illustrating a sliding door closing sequence in accordance with one aspect of the disclosure;

FIG. 8 is a side view of a sliding door illustrating a mechanical sliding door closure system in accordance with prior art within an internal cavity of the sliding door;

FIG. 9 illustrates a side-by-side comparison of at least some of the prior art hardware components and/or sub-assemblies eliminated and/or replaced in the sliding door closure system of the present disclosure when compared to the conventional sliding door closure system of the prior art;

FIG. 9A illustrates a sliding door closure system in accordance with an illustrative embodiment; and

FIGS. 10A to 10C are flowcharts of operations performed by a latch electronic control unit (ECU) of a sliding door system of FIG. 3, in accordance with illustrative embodiments.

### DETAILED DESCRIPTION OF EXAMPLE EMBODIMENTS

The example embodiments will now be described more fully with reference to the accompanying drawings.

One or more example embodiments of a motor vehicle sliding door closure system for a motor vehicle sliding door constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

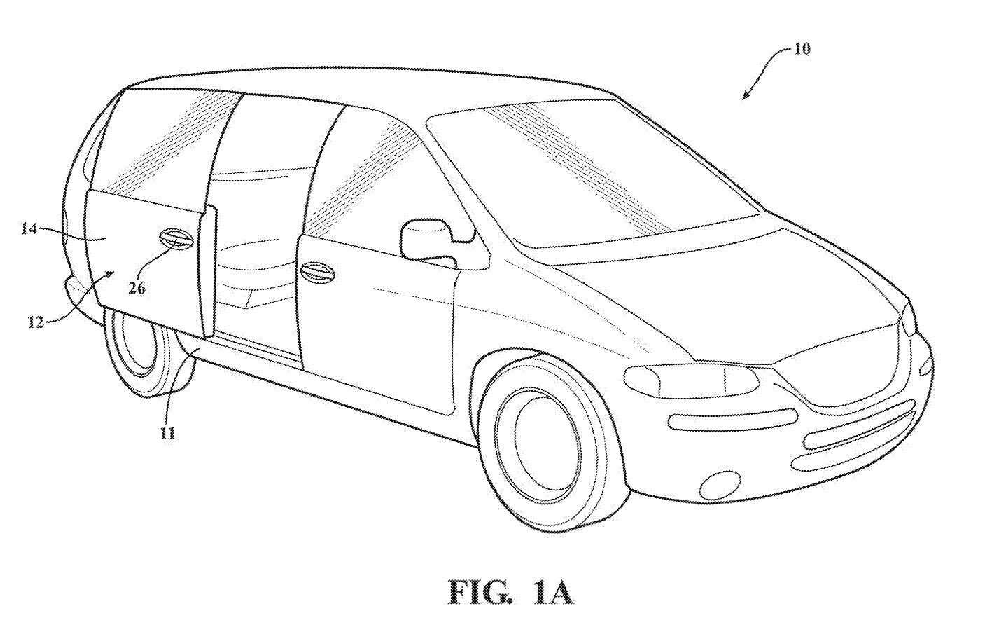

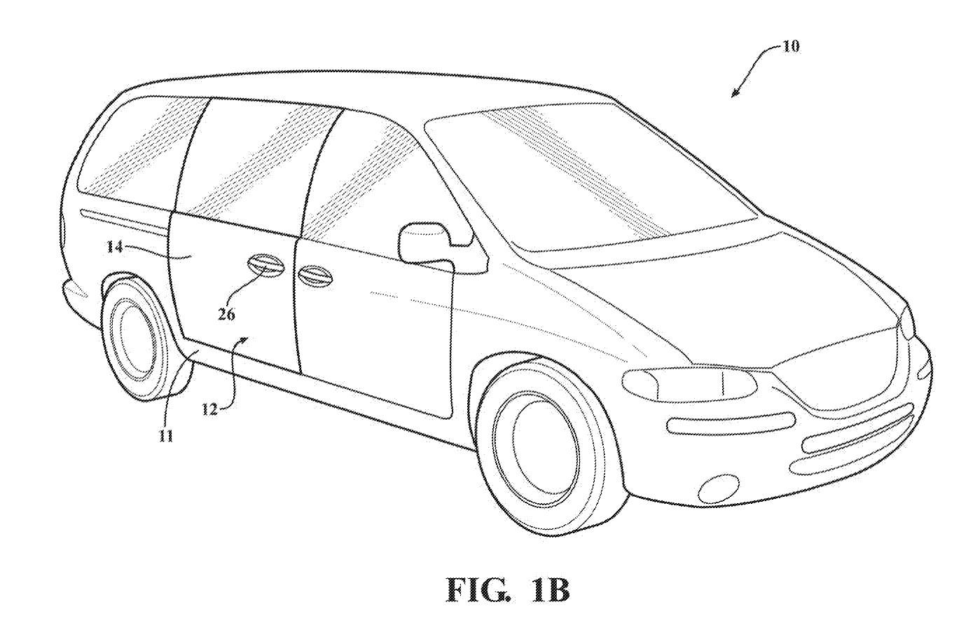

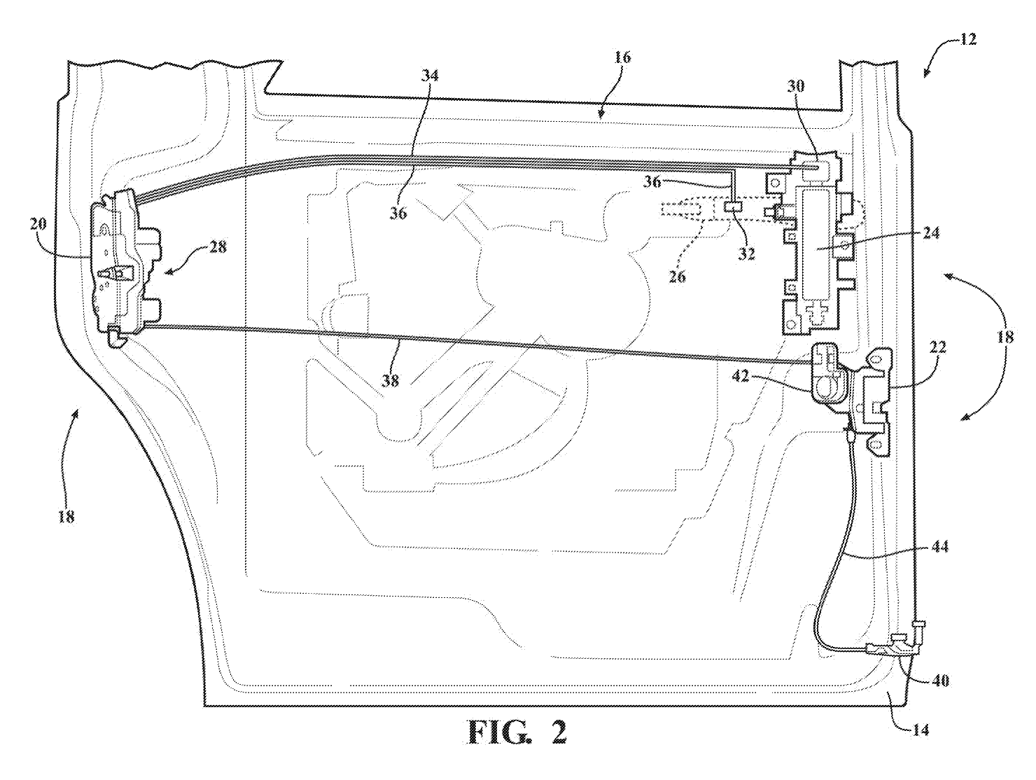

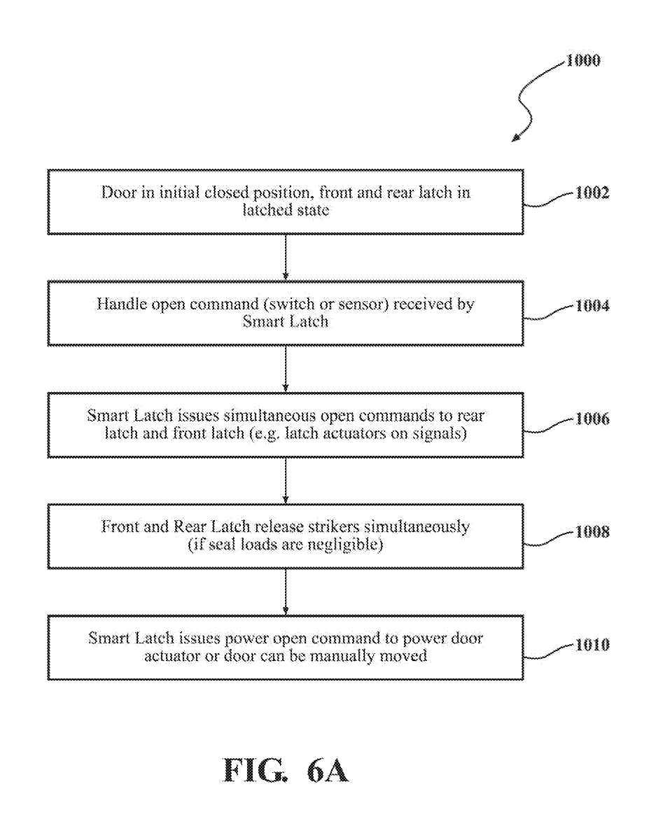

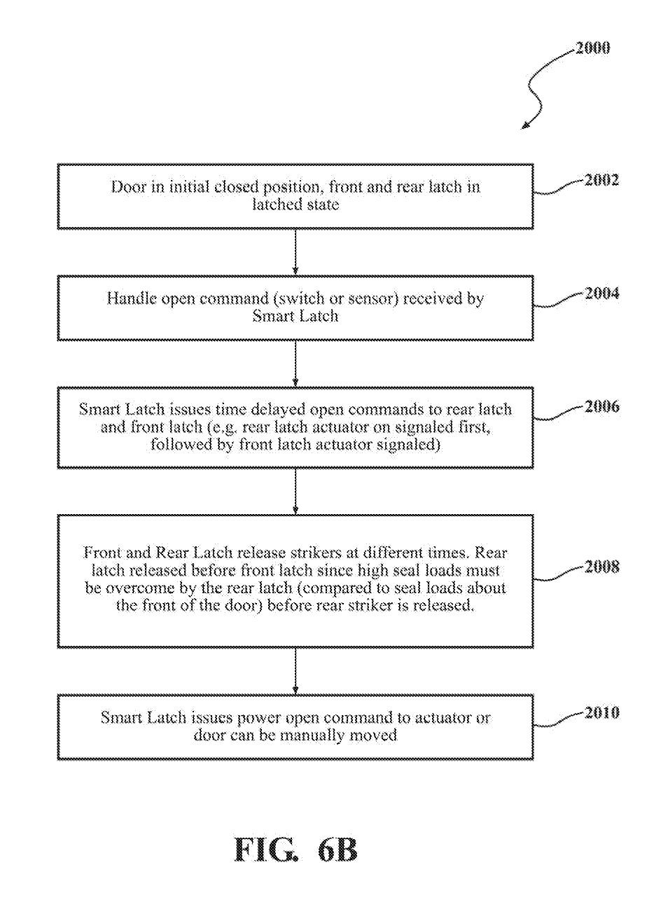

FIGS. 1A and 1B illustrate a motor vehicle 10 having a vehicle body 11 configured to support a door 12, and illustratively exemplified a sliding door 12 for sliding translation between open (FIG. 1A) and closed (FIG. 1B) positions. It is recognized the teachings herein may be applied to other types of closure panels, such as a lift gate, pivoting side doors such as the type provided on pickup trucks without limitation, decklids, hoods, trunks, sunroofs, gulfwing type doors, suicide doors, as well as other vehicle closure panels. Sliding door 12 includes a structural door body 14 defining an internal cavity 16 (FIG. 2) with a sliding door closure system 18 installed within the internal cavity 16, at least in part, in accordance with one aspect of the disclosure. In a non-limiting embodiment of the disclosure, the sliding door closure system 18 is shown including a latch control system 28 with an electrical rear latch 20 and an electrical front catch 22 configured in electrical communication with the electrical rear latch 20, wherein selective actuation of the electrical rear latch 20 directly causes synchronized, concurrent (FIG. 6A) or precisely timed (FIG. 6B) electrical actuation of the electrical front catch 22. It is recognized that electrical rear latch 20 is an illustrative embodiment of an electrical first latch 97 and electrical front catch 22 is an illustrative embodiment of an electrical second latch 95. It is recognized that electrical first latch may be a catch type while electrical second latch may be a latch type, or both electrical first latch and electrical second latch are latch types, or both electrical first latch and electrical second latch are catch types. While two electrical first latch 97 and electrical second latch 95 are illustrated, it is recognized that two or more electrical latches may be provided and controlled by electrical communication, and/or in electrical communication with each other.

As an improvement over conventional sliding door 1, the present disclosure provides an optimized sliding door 12 which is equipped with electrical rear latch 20, which is provided as a fully-electrical latch, also referred to, solely for identification purposes hereafter, as “E-Latch” or “Smart Latch”. Smart Latch 20 is configured not to have mechanical linkages and/or mechanical connector mechanisms to an inside door handle 24 or outside door handle 26 of sliding door 12, thereby, amongst other things that will be recognized by one possessing ordinary skill in the art, simplifying assembly and reducing costs associated therewith, including reducing inventory cost, while also enhancing design flexibility of sliding door 12 by reducing the number of components having to be contained within internal cavity 16 of sliding door 12, and further, reducing weight of the door 12, thereby improving fuel economy of the motor vehicle 10. Instead, sliding door 12 is unlocked and released by the electrically signaled, power-operated actuator(s) associated with Smart Latch 20 in response to an electrical signal coming from the latch control system 28 of Smart Latch 20. By providing an electrically commanded operation of Smart Latch 20, the openings, through-holes, or like interfaces typically present in the conventional sliding door 1 for accommodating the passage of mechanical linkages and/or mechanical connector mechanisms, or other connector types can be reduced and/or eliminated, thereby further reducing cost associated with the manufacture of vehicle door 12 and also providing for enhanced sealing of the internal cavity 16 of sliding door 12 with less likelihood of water ingress. The latch control system 28 can include an inside micro-switch 30 and an outside micro-switch 32, both of which are configured in electrical communication with the electrical rear latch 20 for selective actuation thereof. As shown, the electrical rear latch 20 is connected via an inside electrical communication member or connector, such as an inside electrical wire 34, by way of example, to the inside micro-switch 30. The inside micro-switch 30 can be mounted to an inner portion of the sliding door body 14 so as to be located within a passenger compartment of the motor vehicle 10, such as being positioned on the trim panel or another surface of sliding door 12 within the passenger compartment. As such, the inside micro-switch 30 can be selectively activated by a passenger within the passenger compartment to selectively actuate the electrical rear latch 20 and front catch 22 in synchronized, concurrent fashion with one another. The inside micro-switch 30 could be placed directly on the inside door handle 24, if desired. It is to be recognized that the inside micro-switch 30 can be provided in many different forms, including as a button, having an ability for non-contact gesture recognition and/or touch activation, or otherwise. Similarly, electrical rear latch 20 is also connected via an outside communication member or electrical connector, such as an outside electrical wire 36, by way of example, to the outside micro-switch 32 located on outside door handle 26 or another surface on the outer door panel of sliding door 12, such that the outside micro-switch 32 can be selectively activated to selectively actuate the electrical rear latch 20 and front catch 22 in synchronized, concurrent fashion with one another, as discussed further below. As discussed above for inside micro-switch, it is to be recognized that the outside micro-switch 32 can be provided in many different forms, including as a button, as having an ability for non-contact gesture recognition and/or touch activation, or otherwise. It is to be further recognized that inside and outside door handles 24, 26, if provided, serve primarily as locations for pulling and pushing the door open and closed, and not as mechanical mechanisms or mechanically actuatable actuators for mechanically unlatching the electric rear latch 20.

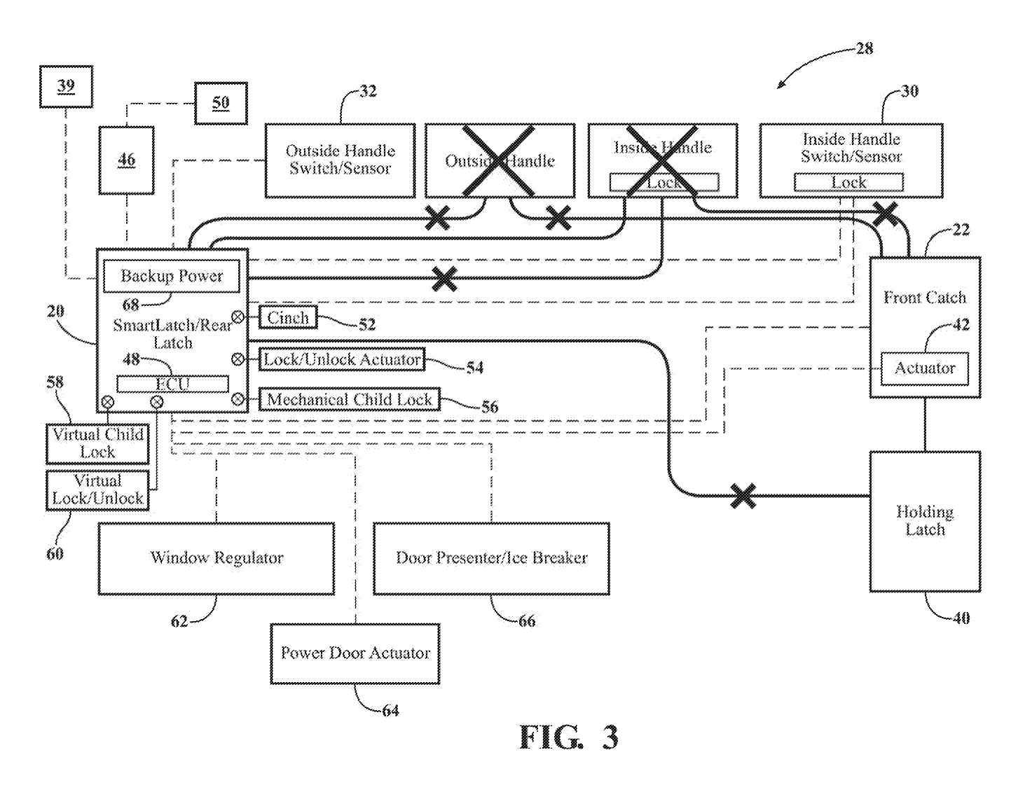

The electrical rear latch 20 is further configured in electrical communication with front catch 22, such as via a front catch communication member, such as an electrical wire 38, by way of example and without limitation. As such, latch control system 28 of Smart Latch 20 is able to signal front catch 22, either in simultaneous (concurrent) synchronized fashion (FIG. 6A) or in some precisely timed and intentionally delayed fashion (FIG. 6B), upon receiving a signal from either one of inside or outside micro-switch 30, 32, or from a key fob 39 (FIG. 3) or the like, in order to actuate release electrical rear latch 20 and front catch 22 in some predetermined relation with one another, whether synchronized or otherwise, depending in part on the nature of the sealing between the sliding door 12 and the vehicle body 11. If the sealing is relatively light, synchronized release between the electrical rear latch 20 and the front catch 22 may be preferred, while if the sealing is relatively tight with a high seal load, such is typical proximate the rear latch 20, it may be preferred to time the release of the front catch 22 in slightly delayed response to the release of the rear latch 20, thereby avoiding an excessive “popping” noise/movement and sudden breaking of the seal. Regardless, it is to be understood that the relative timing of release of the rear latch 20 and front catch 22 can be precisely controlled and maintained via programmed logic within the latch control system 28 of Smart Latch 20. Also, seal load differences between different positions of the sliding door 12, such as front seals 99a versus rear seals 99b may affect the latching of front catch 22 compared to electrical rear latch 20.

In accordance with a further aspect, the sliding door 12 can be provided with a holding latch 40 configured to releasably maintain the sliding door 12 in a fully open position (FIG. 1A). Holding latch 40 is shown as being in electro-mechanical communication with Smart Latch 20 via front catch 22, wherein the holding latch 40, by way of example and without limitation, is shown as being connected in direct communication with a mechanical actuator 42 of front catch 22 via a holding latch cable 44, such as a Bowden style cable, for example. As such, the latch control system 28 of Smart Latch 20 is configured in operable communication with holding latch 40 via the actuator 42 (FIGS. 2, 4 and 9) of front catch 22. Accordingly, when desired to release the holding latch 40 from its latched engagement with a striker or the like (not shown) fixed on vehicle body 11 in order to close the sliding door 12, a signal can be sent to latch control system 28 of Smart Latch 20, such as from inside or outside micro-switch 30, 32, or from key fob 39, whereupon Smart Latch 20 can send a signal to the actuator 42 to cause holding latch cable 44 to move holding latch 40 from its latched position to an unlatched position.

Now referring back to FIG. 3, wherein certain features of the prior art sliding door 1, including various cables and mechanisms have been crossed out as not being included in the sliding door 12 of the present disclosure, the Smart Latch 20 is shown electrically connected to a main power source 46 of the motor vehicle 10, for example a main battery providing a battery voltage V_{batt} of 12 V, through an electrical connection element, for example a power cable (the main power source may equally include a different source of electrical energy within the motor vehicle 10, for example an alternator). The Smart Latch 20 includes an actuation group, including an electric motor, operable to control actuation of the sliding door 12, such as disclosed both structurally and operationally in commonly-owned U.S. Pat. No. 9,353,556, filed Jun. 27, 2017, and incorporated herein by reference in its entirety. Another example of a latch is disclosed in in commonly-owned U.S. Patent Publication No. US2018/0100331, filed Sep. 27, 2017, and incorporated herein by reference in its entirety.

In a possible embodiment, the actuation group includes a ratchet, which is selectively rotatable to engage a striker (fixed to the body 11 of the motor vehicle 10, for example to the so called “A pillar” or “B pillar”, in a manner not shown in detail). When the ratchet is rotated into a latching position with respect to the striker, the sliding door 12 is in a closed operating state. A pawl selectively engages the ratchet to prevent it from rotating, driven by an electric motor so as to move between an engaged position and a non-engaged position.

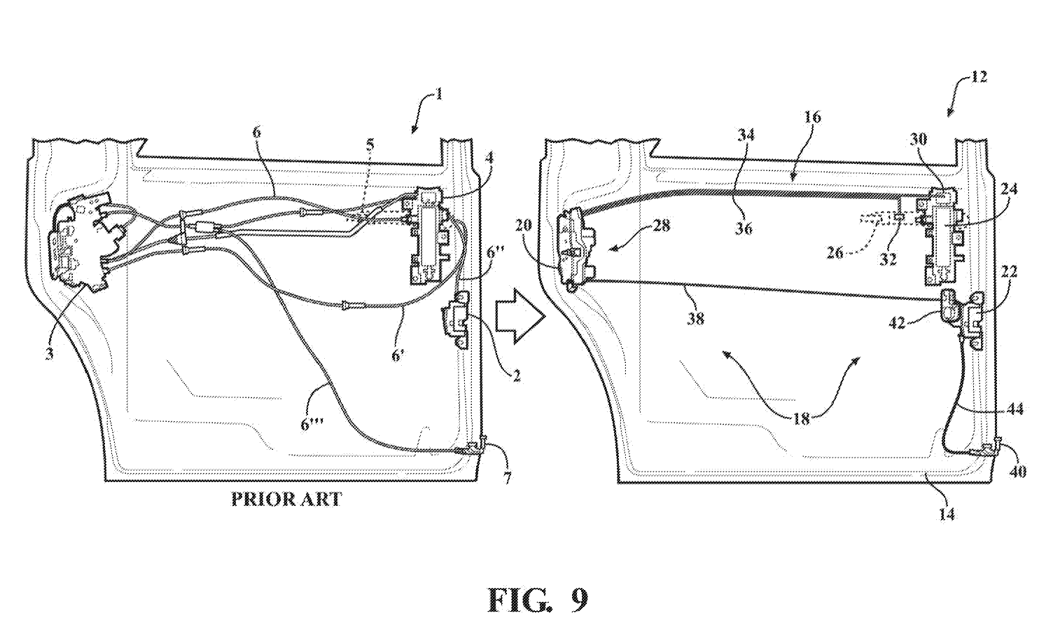

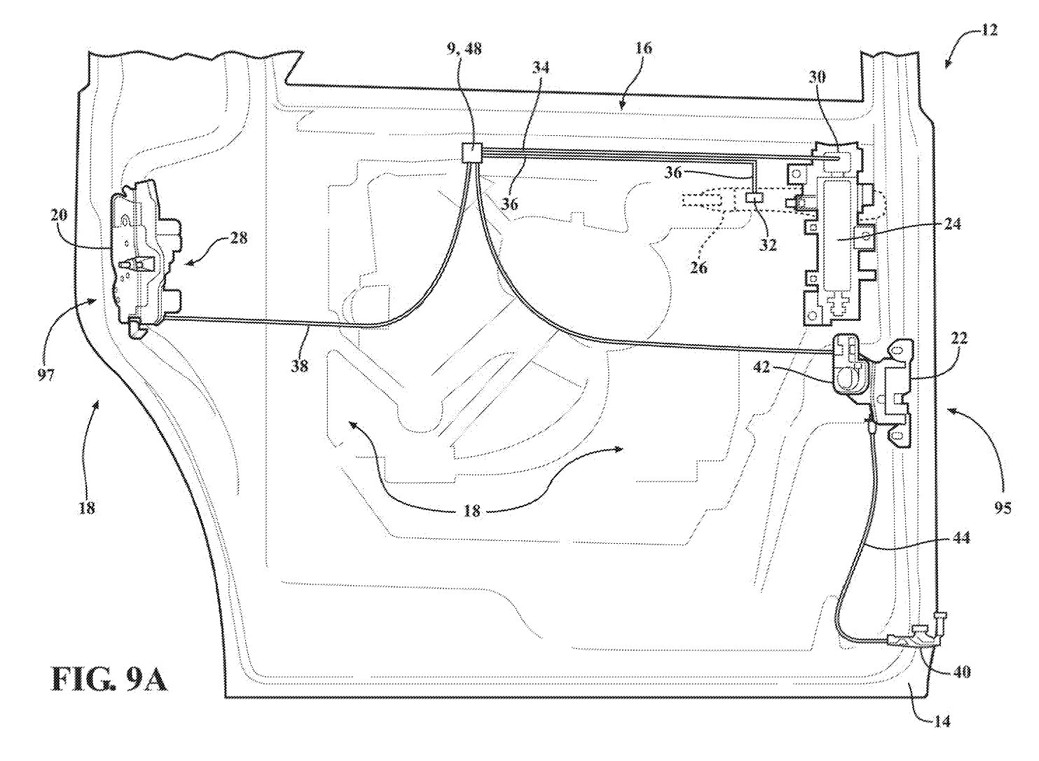

The Smart Latch 20 further includes a latch electronic control unit (ECU) 48, for example including a microcontroller or other known computing unit, which may be conveniently embedded and arranged in a same housing or case (shown schematically) with the actuation group, thus providing an integrated compact and easy-to-assemble unit. In accordance with the illustrated embodiment, latch electronic control unit (ECU) 48 is integrated with the smart latch 20. It is recognized that latch electronic control unit (ECU) 48 may be provided separate from smart latch 20, for example as part of a door control module 9 in electrical communication with the first electrical latch 97 and the second electrical latch 95 as illustrated in FIG. 9A in accordance with an illustrative embodiment. Also illustrated in accordance with an example is inside or outside micro-switches 30, 32 or an associated sensor, such as via key fob 39 in electrical communication with door control module 9. Latch electronic control unit (ECU) 48 includes a microcontroller, microprocessor or analogous computing module mounted on a printed circuit board (not shown). The Latch electronic control unit (ECU) 48 has an embedded memory, for example a non-volatile random access memory, coupled to the computing module, storing suitable programs and computer instructions (for example in the form of a firmware). It is recognized that Latch electronic control unit (ECU) 48 may alternatively comprise a logical circuit of discrete components to carry out the functions of the computing module and memory.

The latch ECU 48 is electrically coupled to a vehicle main management unit (also known as main ECU or “vehicle body computer”) 50, which is configured to control general operation of the motor vehicle 10, so as to exchange signals, data, commands and/or information.

Moreover, as shown also in FIG. 3, the latch ECU 48 can be (directly, and/or indirectly via the vehicle management unit 50) electronically coupled to one or more different devices (shown schematically) of the motor vehicle 10, such as: cinch 52, which is configured to bias the sliding door 12 into a fully locked position; lock/unlock actuator 54; mechanical child lock 56; virtual child lock 58; virtual lock/unlock 60; window regulator 62; power door actuator 64; and door presenter/ice breaker 66, by way of example and without limitation.

With the latch ECU 48 being coupled to the main power source 46 of the motor vehicle 10, so as to receive the battery voltage V_{batt}; the latch ECU 48 is able to check if the value of the battery voltage V_{batt} decreases below a predetermined threshold value, to promptly determine if an emergency condition (when a backup energy source may be needed) occurs.

As shown in the schematic block diagram of FIG. 3, the latch ECU 48 includes an embedded and integrated backup power source 68, which is configured to supply electrical energy to the actuation group and latch electric motor, and to the same latch ECU 48, in case of failure or interruption of the main power supply from the main power source 46 of the motor vehicle 10.

According to an aspect of the disclosure, the backup energy source 68 includes a group of low voltage supercapacitors (hereinafter supercap group), as an energy supply unit (or energy tank) to provide power backup to the Smart Latch 20, even in case of power failures. Supercapacitors may include electrolytic double layer capacitors, pseudocapacitors or a combination thereof.

Supercapacitors advantageously provide high energy density, high output current capability and have no memory effects; moreover, supercapacitors have small size and are easy to integrate, have extended temperature range, long lifetime and may withstand a very high number of charging cycles. Supercapacitors are not toxic and do not entail explosive or fire risks, thus being suited for hazardous conditions, such as for automotive applications.

As noted, operation of the componentry associated with sliding door 12 can be controlled via logic associated with Smart Latch 20. Accordingly, the cinch 52; lock/unlock actuator 54; mechanical child lock 56; virtual child lock 58; virtual lock/unlock 60; window regulator 62; power door actuator 64; and door presenter/ice breaker 66, by way of example and without limitation, can all be controlled via logic associated with Smart Latch 20.

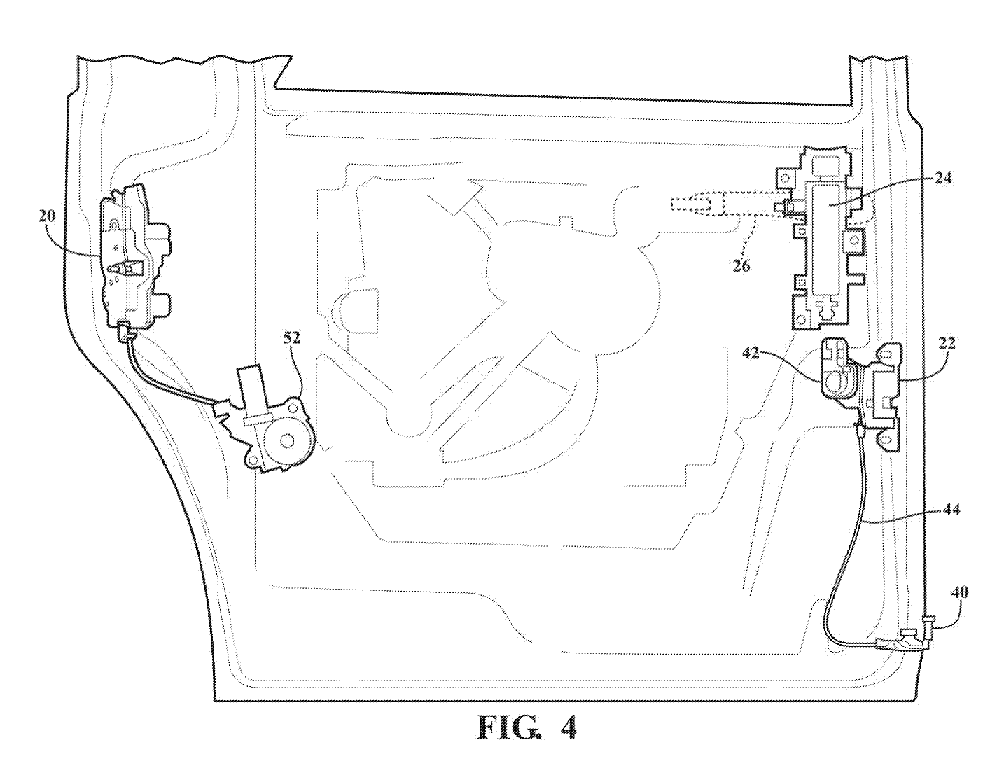

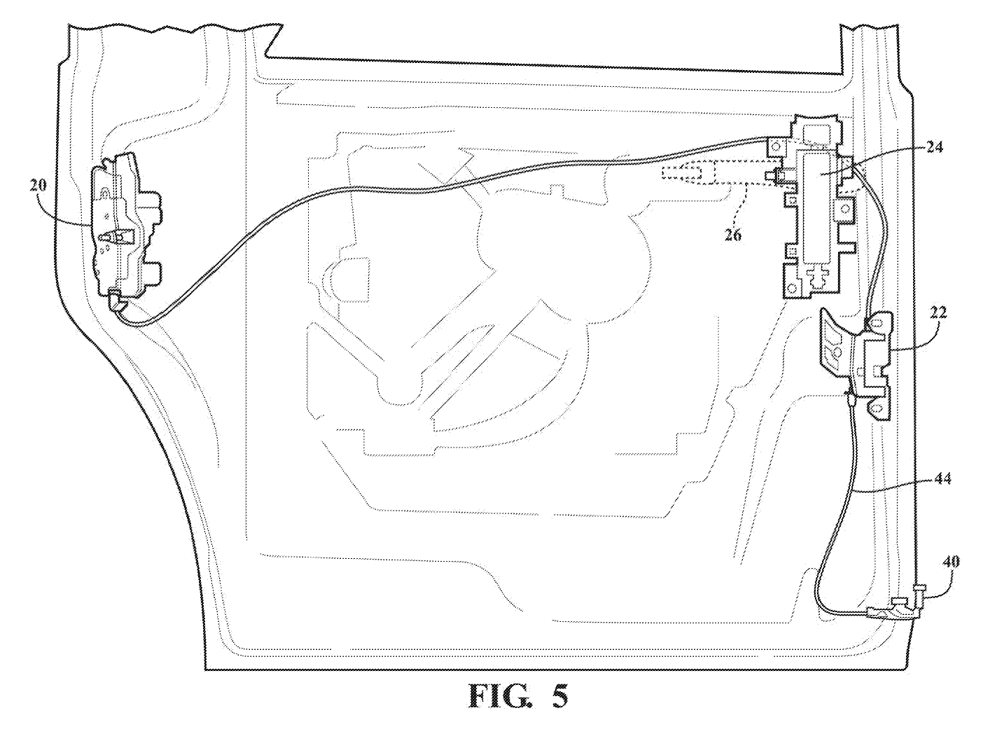

As mentioned above, sliding door 12 provides significant advantages over conventional sliding door 1, including, among other things, which will be readily apparent to a person possessing ordinary skill in the art upon viewing the disclosure herein, enhanced performance over an increased useful life, weight reduction, assembly reduction (number of separate components needed and time for assembly significant reduced), cost reduction as well as new styling opportunities presented by unused space as a result of deletion of some conventional door hardware components. FIG. 3 illustrates the “crossed out” door hardware components of conventional sliding door 1 that are no longer required since sliding door 12 is now equipped with Smart Latch 20 and the electrically connected components discussed above. FIG. 4 illustrates the optional incorporation of cinch 52 and mechanical front catch 40, and FIG. 5 illustrates a further aspect for incorporation of mechanical front catch 40.

FIGS. 6A and 6B illustrate optional variations of methods 1000, 2000, respectively, of an opening sequence of sliding door 12 in accordance with the disclosure, with the notable difference being with regard to the timing of actuation between the rear latch 20 and front catch 22. In FIG. 6A, rear latch 20 and front latch 22 are released simultaneously with one another, whereas in FIG. 6B, the release of front catch 22 is delayed relative to the release of rear latch 20, such as may be beneficial in a scenario of high seal loads, as discussed above. Otherwise, the sequence of steps is the same, as diagrammatically illustrated. Initially, at step 1002, 2002, respectively, both sequences 1000, 2000 start with the door, such as sliding door 12, in the closed position and the front and rear latches 20, 22 in the latched state. Then, handle open command can be triggered at step 1004, 2004, respectively, such as via switch or sensor (30, 32). Upon the rear latch 20 and front catch 22 being released at step 1006 (simultaneous release of strikers at step 1008), 2006 (delayed release of strikers at step 2008) via smart latch 20, the sliding door 12 may be manually opened at step 1010, 2010, or, at step 1010, 2010 the Smart Latch 20 may signal the power door actuator 64 to open the sliding door 12, whereupon the holding latch 40 may be actuated via Smart Latch 20 signaling actuator 42 of front catch 22 via electrical wire 38 to move holding latch 40 to its locked position to prevent inadvertent closing of the sliding door 12 from the open position. Whereas a sliding door outfitted with mechanically actuatable cables/rods interconnecting the hardware components with one another may experience a detuning/desynchronization of the opening sequence over time due the degradation of component tolerances or development of slack in the system (e.g. cable slack), the timing sequence of actuations of the present sliding door 12 remains tuned and synchronized due to the elimination of these sources of degradation and slack.

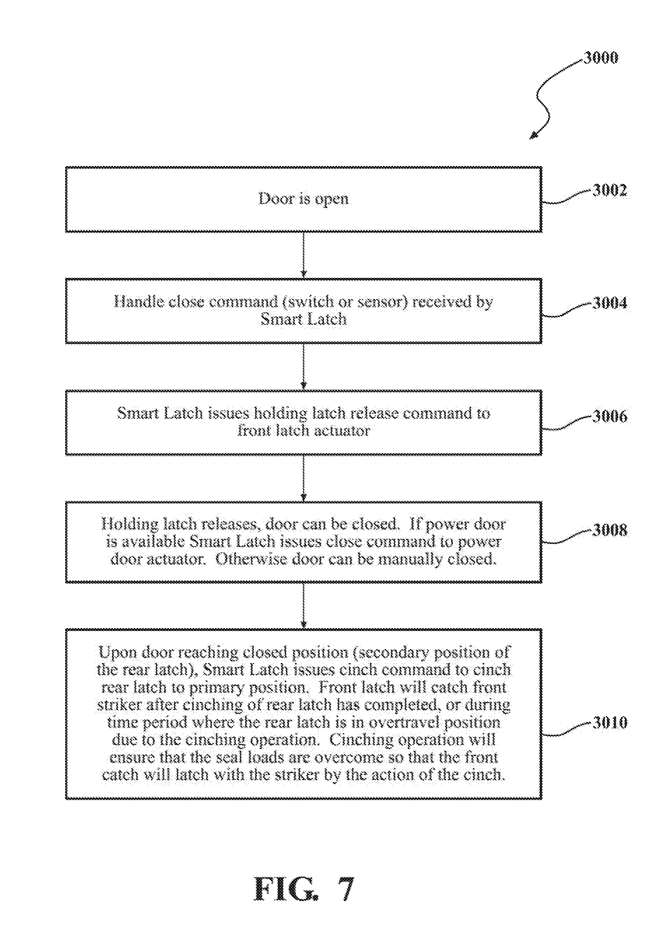

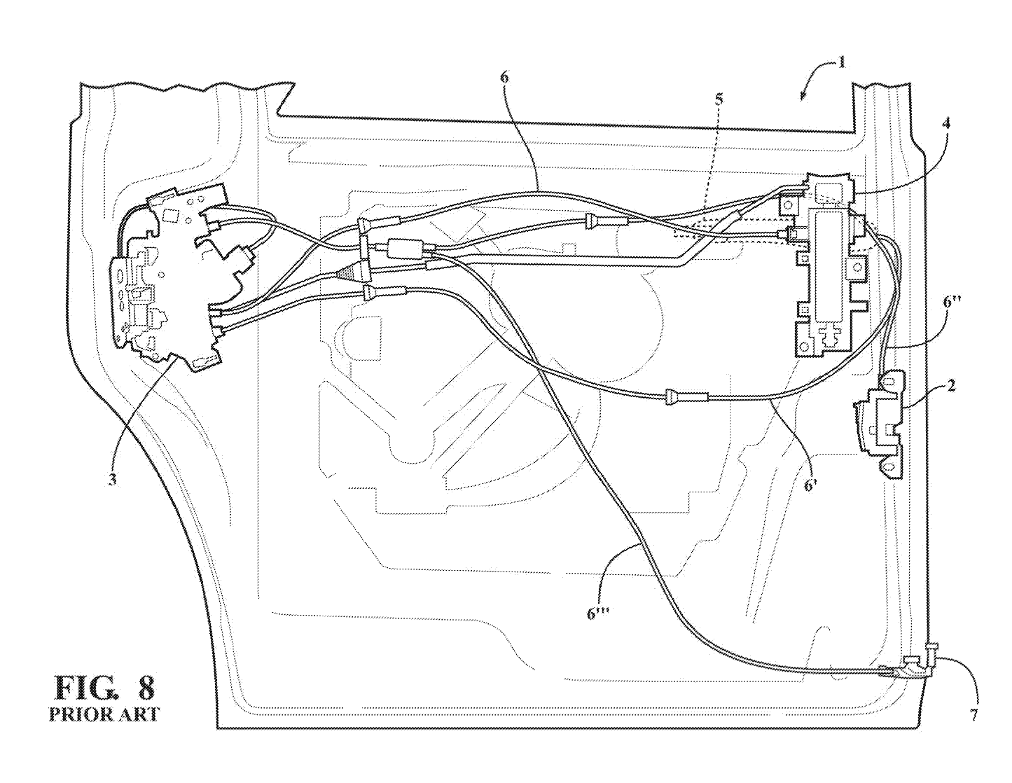

FIG. 7 illustrates a method 3000 including a sequence of steps for actuation sliding door 12 via Smart Latch 20 to move from the fully open position at step 3002 to the fully closed position at step 3010. First, at step 3004 a close signal (command) is sent to Smart Latch 20 via triggering one of the inside or outside micro-switches 30, 32 or an associated sensor, such as via key fob 39, as discussed above. At step 3006 Smart Latch 20 then signals actuator 42 of front catch 22 to move holding latch 40 to its unlocked position, whereupon, at step 3008 sliding door 12 can be manually closed, or, the Smart Latch 20 may signal the power door actuator 64 to close the sliding door 12. Then, at step 3010, upon the sliding door 12 reaching the closed position, Smart Latch 20 may signal cinch 52, if provided, to bring the sliding door 12 to its fully locked position via locking of rear latch 20 and front catch 22 with their respective strikers.

In accordance with another aspect of the disclosure, a method of allowing sliding movement of a vehicle sliding door 12 between a closed position and an open position is provided. The method includes installing a sliding door closure system 18 within an internal cavity 16 of the vehicle sliding door 12 and providing the sliding door closure system 18 including an electrically actuatable rear latch 20 and an electrically actuatable front catch 22. Further, configuring the electrically actuatable rear latch 20 and the electrically actuatable front catch 22 in electrical communication with one another via at least one communication member, such as an electrical wire 38, and configuring the electrically actuatable front catch 22 to be electrically actuated in response to selective electrical actuation of the electrically actuatable rear latch 20.

In accordance with a further aspect, as shown in FIG. 6A, the method can further include configuring the electrically actuatable front catch 22 to be electrically actuated in simultaneous response to electrical actuation of the electrically actuatable rear latch 20.

In accordance with a further aspect, as shown in FIG. 6B, the method can also include configuring the electrically actuatable front catch 22 to be electrically actuated in delayed response (fractions of a second to seconds) to electrical actuation of the electrically actuatable rear latch 20, thereby allowing sealing pressure between the sliding door 12 and the vehicle body 11 to be gently released to avoid a sudden “popping” noise.

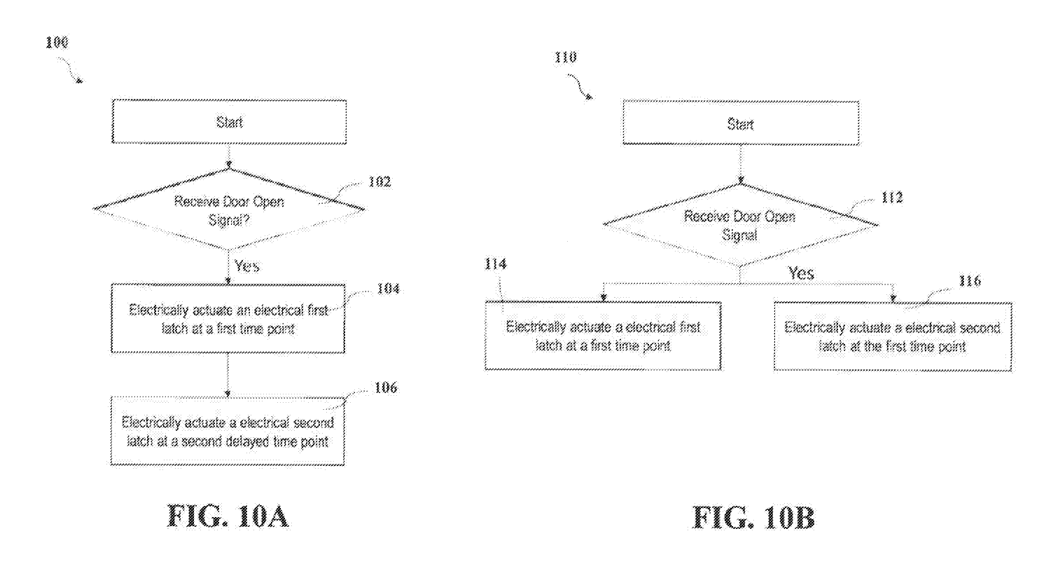

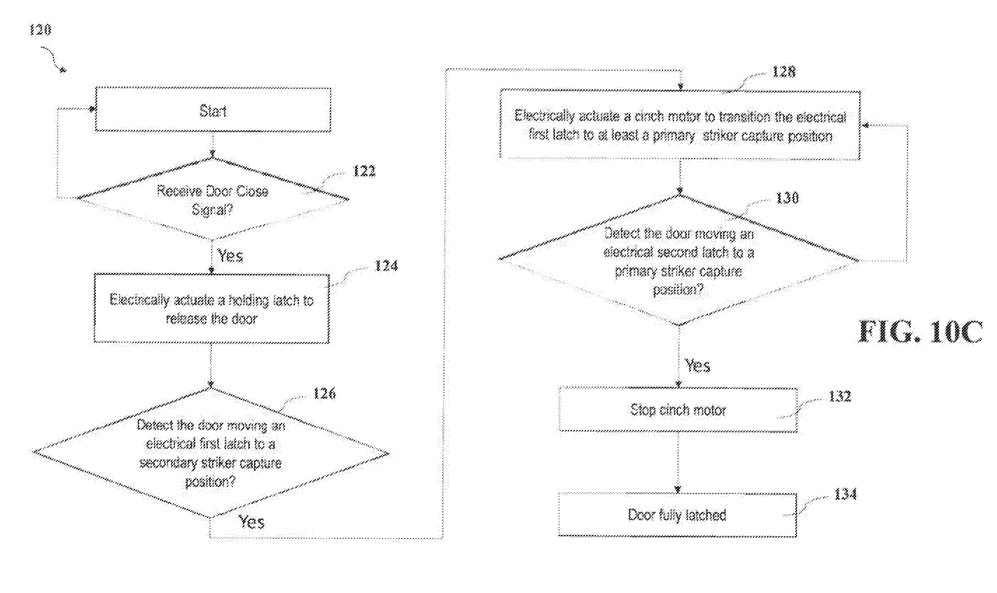

Now referring to FIGS. 10A to 10C, there are illustrated software flow diagrams representative of instructions stored in memory executed by computing module of latch electronic control unit (ECU) 48. For example, FIG. 10A illustrates a flow diagram executed by the latch electronic control unit (ECU) 48 for controlling a door unlatching operation 100. At step 102, if latch electronic control unit (ECU) 48 receives a door open signal from one of inside micro-switch 30 and an outside micro-switch 32 for example, latch electronic control unit (ECU) 48 at step 104 electrically actuates an electrical first latch at a first time point, for example at Time=0. After a delayed time, latch electronic control unit (ECU) 48 at step 106 may electrically actuate an electrical second latch at a second time point, for example at Time=0.7 seconds. Such a delayed release of electrical first latch from release of electrical second latch may allow the seal loads to be overcome at a gradual rate, thereby reducing pop-out noise, for example. Other advantages such as improved synchronization of first and second latch release due to different seal loading acting on the door 12 proximate the associated latch may be provided. For example FIG. 10B illustrates a flow diagram executed by the latch electronic control unit (ECU) 48 for controlling a door unlatching operation 110. At step 112, if latch electronic control unit (ECU) 48 receives a door open signal from one of inside micro-switch 30 and an outside micro-switch 32 for example, latch electronic control unit (ECU) 48 at step 114 electrically actuates an electrical first latch at a first time point, for example at Time=0. Simultaneously, latch electronic control unit (ECU) 48 at step 116 may electrically actuate an electrical second latch the same time point Time=0. Such a simultaneous release of electrical first latch and release of electrical second latch may allow the seal loads simultaneously act on the door 12, thereby assisting the release of the electrical first latch and release of electrical second latch, for example due to a low seal load acting on door 12. Other advantages such as improved synchronization of first and second latch release due to the same seal loading acting on the door 12 proximate the associated latch may be provided.

For example FIG. 10C illustrates a flow diagram executed by the latch electronic control unit (ECU) 48 for controlling a door closing and cinching operation 120. At step 122, if latch electronic control unit (ECU) 48 receives a door open signal from one of inside micro-switch 30 and an outside micro-switch 32 for example, latch electronic control unit (ECU) 48 at step 124 electrically actuates a holding latch to release the door. At step 126, latch electronic control unit (ECU) 48 detects the door moving an electrical first latch to a secondary striker capture position, and proceeds in response to electrically actuate a cinch motor to transition the electrical first latch to at least a primary striker capture position at step 128. At step 130, latch electronic control unit (ECU) 48 detects the door moving an electrical second latch to a primary striker capture position, and in response proceeds to stop operation of a cinch motor at step 132. In step 134, the door is determined by the latch electronic control unit (ECU) 48 to be fully closed and latched, and may transmit a door latch signal to a vehicle Body Control Module (BCM) or other vehicle system for example.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A door closure system for a motor vehicle door that is moveable between an open position and a closed position, comprising:
an electrical first latch and an electrical second latch configured in electrical communication with a controller configured for controlling activation of said electrical first latch and said electrical second latch, said electrical first latch and said electrical second latch being electrically actuatable in direct response to selective electrical actuation of by said controller.

2. The door closure system of claim 1, wherein the door closure system is a sliding door closure system for a motor vehicle sliding door that is slidable between an open position and a closed position,
wherein said first electrical latch is an electrical latch and said second electrical latch is an electrical catch configured in electrical communication the controller, said controller configured to electrically actuate said electrical catch and said electrical latch.

3. The sliding door closure system of claim 2, wherein the controller is provided in the electrical latch, the electrical latch and an electrical catch configured in electrical communication with one another, said electrical catch being electrically actuatable in direct response to selective electrical actuation of said electrical latch.

4. The sliding door closure system of claim 3, further including at least one selectively actuatable electrical switch configured in electrical communication with said electrical latch.

5. The sliding door closure system of claim 4, wherein said at least one electrical switch includes an inside electrical switch and an outside electrical switch configured in electrical communication with said electrical latch.

6. The sliding door closure system of claim 5, further including a holding latch configured in operable communication with said electrical catch, said holding latch being configured to move to a locked position to maintain the motor vehicle sliding door in the open position and to a released position to allow the motor vehicle sliding door to move toward the closed position.

7. The sliding door closure system of claim 6, wherein said electrical catch has an actuator configured to move the holding latch between said locked position and said released position.

8. The sliding door closure system of claim 1, wherein said controller electrically actuates said electrical first latch and said electrical second latch simultaneously.

9. The sliding door closure system of claim 1, wherein said controller electrically actuates said electrical first latch in delayed response to electrical actuation of said of said electrical second latch.

10. The sliding door closure system of claim 1, wherein at least one of said electrical first latch and said electrical second latch is free of any mechanical connections.

11. A motor vehicle sliding door, comprising:
a structural door body defining an internal cavity;
a sliding door closure system installed within said internal cavity, said sliding door closure system including an electrical rear latch and an electrical front catch configured in electrical communication with one another, said electrical front catch being electrically actuatable in direct response to selective electrical actuation of said electrical rear latch.

12. The motor vehicle sliding door of claim 11, further including a holding latch configured in operable communication with said front catch, said holding latch being configured to move to a locked position to maintain the motor vehicle sliding door in an open position and to a released position to allow the motor vehicle sliding door to move toward a closed position.

13. The motor vehicle sliding door of claim 12, further including an actuator configured to move the holding latch between said locked position and said released position.

14. The motor vehicle sliding door of claim 13, wherein said actuator is configured to move said holding latch between said locked position and said released position in response to a signal from at least one of said electrical rear latch and a selectively actuatable electrical switch.

15. The motor vehicle sliding door of claim 14, wherein said actuator is configured in direct electrical communication with said electrical rear latch.

16. The motor vehicle sliding door of claim 11, wherein said electrical front catch is electrically actuatable in simultaneous response to actuation of said electrical rear latch.

17. The motor vehicle sliding door of claim 11, wherein said electrical front catch is electrically actuatable in delayed response to actuation of said electrical rear latch.

18. A method of allowing sliding movement of a vehicle sliding door between a closed position and an open position, comprising:
installing a sliding door closure system within an internal cavity of the vehicle sliding door;
providing the sliding door closure system including an electrically actuatable rear latch and an electrically actuatable front catch;
configuring the electrically actuatable rear latch and the electrically actuatable front catch in electrical communication with one another; and
configuring the electrically actuatable front catch to be electrically actuated in response to selective electrical actuation of the electrically actuatable rear latch.

19. The method of claim 18, further including configuring the electrically actuatable front catch to be electrically actuated in simultaneous response to electrical actuation of the electrically actuatable rear latch.

20. The method of claim 18, further including configuring the electrically actuatable front catch to be electrically actuated in delayed response to electrical actuation of the electrically actuatable rear latch.
